(19) United States
(12) Patent Application Publication
(10) Pub. No.: US 2026/0255014 A1
(43) Pub. Date: Aug. 27, 2026

(54) SYSTEMS AND METHODS FOR COLLECTION ASSEMBLY AND PRODUCTION OF CONTENT THROUGH USE OF AGGREGATED ASSETS AND GENERATIVE MACHINE-LEARNING ALGORITHMS

(71) Applicant: DreamKey Syndicate, Inc., Newcastle, WA (US)

(72) Inventors: William Brierly, Cambridge, MA (US); Sean Baptiste, North Beach, MD (US); Aaron Bleyaert, Los Angeles, CA (US); Kevin Pereira, Los Angeles, CA (US); Keith Garde, Newcastle, WA (US)

(21) Appl. No.: 19/548,848

(22) Filed: Feb. 24, 2026

Related U.S. Application Data
(60) Provisional application No. 63/763,096, filed on Feb. 25, 2025.
(60) Provisional application No. 63/763,066, filed on Feb. 25, 2025.
(60) Provisional application No. 63/763,010, filed on Feb. 25, 2025.

(51) Int. Cl. H04N 21/442; G10L 13/08; H04N 21/43; H04N 21/466

(52) U.S. Cl. CPC H04N 21/44204; G10L 13/08; H04N 21/4307; H04N 21/4667

(57) ABSTRACT

A computing system for audio and video generated content may comprise one or more processors. The one or more processors may be configured to execute stored computer-readable instructions to assemble a plurality of audio assets. The one or more processors may assemble a plurality of video assets. The one or more processors may receive a first set of directives for content generation. The one or more processors may parse the plurality of audio assets, the plurality of video assets and the first set of directives to generate a first rendition of an AV-content presentation. The one or more processors may receive a second set of directives corresponding to consumption of the first rendition. The one or more processors may generate a second rendition of the AV-content presentation that may be different from the first rendition. The computing system may enable dynamic content generation based on audience interaction and consumption patterns.

### PRIORITY CLAIM TO PROVISIONAL PATENT APPLICATIONS

This application claims priority to three U.S. Provisional Patent Applications, all of which were filed on Feb. 25, 2025: (1) U.S. Provisional Patent application No. 63/763,096 entitled “SYSTEMS AND METHODS FOR COLLECTION ASSEMBLY AND PRODUCTION OF CONTENT THROUGH USE OF AGGREGATED ASSETS AND GENERATIVE MACHINE-LEARNING ALGORITHMS,” the entirety of which is incorporated herein by reference, (2) U.S. Provisional Patent application No. 63/763,066 entitled “SYSTEMS AND METHODS FOR GENERATIVE PRODUCTION OF CONTENT WITH ROYALTY TRACKING FOR COPYRIGHTED ASSETS,” the entirety of which is incorporated herein by reference, and (3) U.S. Provisional Patent application No. 63/763,010 entitled “SYSTEMS AND METHODS FOR GENERATIVE PRODUCTION OF MULTI-USER INFLUENCED CONTENT IN REAL-TIME,” the entirety of which is incorporated herein by reference.

### BACKGROUND

Creation and delivery of produced content is in high demand and production facilities are faced with increasingly faster production turnarounds and deadlines. Further, production teams are asked to assemble content and assets from several varying sources for any given project. Individuals may have a difficult time assimilating the vast amount of content available for production, let alone that which is licensed and approved for any given project. For example, assets available may include background images for video production, musical content for audio, 3^{rd}-party owned dialogue content, and animatable imagery. Thus, an individual engineer or team of engineers will spend requisite time identifying content to use, requesting permission, acquiring and assembling the desired content—all before any actual engineering or production takes place. This proves to be even more difficult when dealing with a live production, such as when content is being created on the fly by production teams.

Further, as content is assembled and/or acquired, it is often the burden of the engineering and production team to track usage for the sake of copyright attribution and royalty distribution. As content may be added or edited out, the burden is exacerbated, which takes away from creativity toward the end production. As more and more source material is generated and/or assembled, the problem of individual-based production becomes more about administration and less about art. This is also more difficult in a live production setting. Thus, a need arises for systems and methods that can streamline selection, assembly and use of content form myriad sources when producing content is fast-paced production environments.

### BRIEF DESCRIPTION OF THE DRAWINGS

The subject matter presented herein will now be described, by way of example, with reference to the accompanying drawings, in which:

FIG. 1 is a block diagram of a computing environment for realizing the systems and methods of a content assembly and generation engine that may be used in conjunction with generative content production according to an embodiment of the subject matter disclosed herein;

FIG. 2 is a block diagram of the content assembly and generation engine of FIG. 1 illustrating the architecture and flow of data according to an embodiment of the subject matter disclosed herein;

FIG. 3 is a flow chart illustrating exemplary computer-based method for content assembly and generation according to an embodiment of the subject matter disclosed herein;

FIG. 4 is a block diagram of a modelling and prediction computing block of the computing environment of FIG. 2 according to an embodiment of the subject matter disclosed herein;

FIG. 5 is a hybrid block diagram and flow chart illustrating inputs, factors and weighting influences for generating produced content in the system of FIG. 2 according to an embodiment of the subject matter disclosed herein;

FIG. 6 is a block diagram of a generic computing device for realizing methods leading to predictive engagement management systems and strategies according to one or more embodiments of the subject matter disclosed herein;

FIG. 7 is a block diagram of the reporting engine of FIG. 2 showing integrated components of this module according to an embodiment of the subject matter disclosed herein;

FIG. 8 is a flow chart illustrating exemplary computer-based method for generative production of content with royalty tracking for assets used according to an embodiment of the subject matter disclosed herein;

FIG. 9 is a block diagram of the production engine of FIG. 2 showing integrated components of this module according to an embodiment of the subject matter disclosed herein; and

FIG. 10 is a flow chart illustrating exemplary computer-based method for advertising content during content assembly, generation, and performance that is influenced by multiple consumers in real tome according to an embodiment of the subject matter disclosed herein.

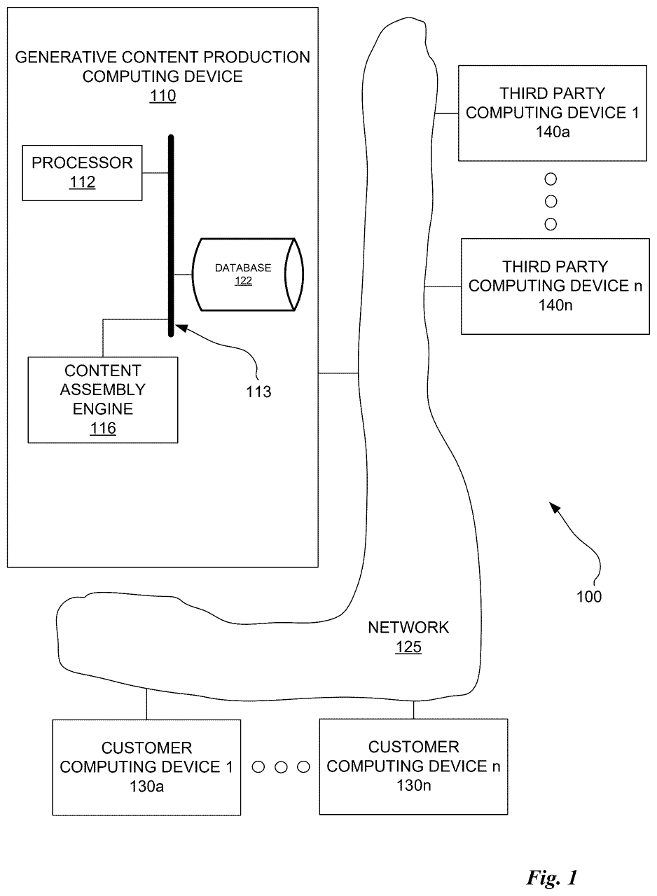

These and other aspects are described below in a detailed description of FIGS. 1-10 in embodiments of the subject matter described herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” as required by 35 U.S.C. § 112.

By way of an overview, systems and methods disclosed herein are directed to a DreamKey™ brain that allows for the performance of fully produced multi-character content with sound design, animation performance, dialogue, and camera direction created in real-time from multiple sources, including the live viewing audience. The DreamKey™ brain is a set of modules built to be used in a rendering engine, such as the Unity Game engine, allowing a user to integrate directed performances into any stream built in Unity. External tools are a set of databases associated with a web-based frontend that the user can engage to create shows.

In an embodiment, a computing system for audio and video generated content may comprise one or more processors configured to execute stored computer-readable instructions. The one or more processors may be configured to assemble a plurality of audio assets. The one or more processors may be configured to assemble a plurality of video assets. The one or more processors may be configured to receive a first set of directives for content generation. The one or more processors may be configured to parse the plurality of audio assets, the plurality of video assets and the first set of directives to generate a first rendition of an AV-content presentation. The one or more processors may be configured to receive a second set of directives corresponding to consumption of the first rendition. The one or more processors may be configured to generate a second rendition of the AV-content presentation that may be different from the first rendition.

### SUMMARY

According to an embodiment of the subject matter disclosed herein, a computing system for audio and video generated content may be provided. The computing system may comprise one or more processors configured to execute stored computer-readable instructions to assemble a plurality of audio assets. The one or more processors may be configured to assemble a plurality of video assets. The one or more processors may be configured to receive a first set of directives for content generation. The one or more processors may be configured to parse the plurality of audio assets, the plurality of video assets and the first set of directives to generate a first rendition of an AV-content presentation. The one or more processors may be configured to receive a second set of directives corresponding to consumption of the first rendition. The one or more processors may be configured to generate a second rendition of the AV-content presentation that may be different from the first rendition.

According to an embodiment of the subject matter disclosed herein, a computer-based method for audio and video generated content may be provided. The method may comprise assembling, by one or more processors, a plurality of audio assets. The method may comprise assembling, by the one or more processors, a plurality of video assets. The method may comprise receiving, by the one or more processors, a first set of directives for content generation. The method may comprise parsing, by the one or more processors, the plurality of audio assets, the plurality of video assets and the first set of directives to generate a first rendition of an AV-content presentation. The method may comprise receiving, by the one or more processors, a second set of directives corresponding to consumption of the first rendition. The method may comprise generating, by the one or more processors, a second rendition of the AV-content presentation that may be different from the first rendition.

Another embodiment may include a reporting engine comprising integrated components configured to track and report usage of content assets. The reporting engine may receive data regarding usage of measured elements during content generation. The measured elements may comprise music, audio samples, voice usage, character usage, art, and character personality elements. The reporting engine may process the usage data to generate reports. The reports may identify consumption of each measured element. The reporting engine may facilitate royalty tracking for assets used in generated content. The reporting engine may communicate with other system components to collect usage information. The reporting engine may aggregate usage data across multiple renditions of content. The reporting engine may generate usage reports for distribution to content creators and rights holders.

According to another embodiment of the subject matter disclosed herein, a production engine may be provided for generating audio and video content. The production engine may comprise one or more processors configured to execute stored computer-readable instructions. The one or more processors may be configured to assemble a plurality of audio assets. The one or more processors may be configured to assemble a plurality of video assets. The one or more processors may be configured to receive a first set of directives for content generation. The one or more processors may be configured to parse the plurality of audio assets, the plurality of video assets and the first set of directives to generate a first rendition of an AV-content presentation. The one or more processors may be configured to receive a second set of directives corresponding to consumption of the first rendition. The one or more processors may be configured to generate a second rendition of the AV-content presentation that may be different from the first rendition.

According to another embodiment of the subject matter disclosed herein, the production engine may comprise integrated components that may include a script generation module. The script generation module may receive input parameters for content creation. The script generation module may process the input parameters to generate a script for the AV-content presentation. The production engine may include a character management module. The character management module may receive a plurality of character definitions. Each character definition may comprise at least one physical attribute, at least one psychological attribute, and at least one voice control parameter. The character management module may associate each character definition with at least one of the plurality of audio assets and at least one of the plurality of video assets. The production engine may include an audio synthesis module. The audio synthesis module may generate audio content for each character using a text-to-speech model. The audio synthesis module may process dialogue from the script to create synthesized speech. The production engine may include a video assembly module. The video assembly module may select video assets corresponding to characters and events in the script. The video assembly module may synchronize the audio content with corresponding video assets. The production engine may include a timeline management module. The timeline management module may receive a timeline definition comprising a plurality of sequential events for the AV-content presentation. The timeline management module may associate each sequential event with at least one character definition. The production engine may include a rendering module. The rendering module may combine the audio content and video assets according to the timeline definition. The rendering module may generate the first rendition of the AV-content presentation. The production engine may include an asset library interface. The asset library interface may provide access to sound effects libraries, music libraries, and location libraries. The production engine may include a modification engine. The modification engine may receive the second set of directives corresponding to consumption of the first rendition. The modification engine may analyze the second set of directives to determine content modifications. The modification engine may generate the second rendition of the AV-content presentation based on the determined content modifications.

These and other aspects of the novel systems and methods may be better understood below in the context and descriptions of FIGS. 1-10.

Turning attention to the figures. FIG. 1 is a block diagram of a generative content platform 100 for realizing the systems and methods for machine-learning generative content production that may be used to identify, assemble, and produce content that may be influenced mid-production by collected analytics according to an embodiment of the subject matter disclosed herein. Herein described, is a generative content platform 100 for providing a solution that allows the subject to analyze consumer and producer feedback utilizing a neural network that engages a machine-learning algorithm for content assembly and production. Further, engineering coordinators and production technicians may be enabled to adjust and optimize selected and generated content with production based on engagement results in conjunction with machine-learning informed feedback.

The generative content platform 100 may be capable of integrating into a subject organization's production ecosystem in order to collect, analyze, process, and produce content and engagements that may be feed-forward influenced, mid-production, with viewer and producer feedback. From the production facility side, the generative content platform 100 includes a generative content production computing device 110 that may be a server-based computing environment realized across one or more distinct computing units. Such a computing device 110 may include a master controller or processor 112 that communicates with other computing modules via a master communication bus 113. Other modules at the generative content production computing device 110 include a content assembly engine 116 and one or more databases 122, all of which may be communicatively coupled to master communications bus 113. Further, the entirety of the generative content production computing device 100 may be communicatively coupled to a computer network 125 (e.g., an intranet, the internet, or both).

Collectively, these computing units/components may facilitate the collection of content from producers and 3^{rd} parties such as producer computing devices 130a-130n (e.g., via content stored in the database 122 received from producers). Within the generative content production computing device 110, the content generation engine 116 facilitates the overall identification, collection, and tracking of content, both generated and produced by others. Further, the generative content production computing device 100 may also be configured to integrate with third party platforms 140a-140n via a computing network 125 such that the producers may effectively collect and utilize third-party content using such third-party services as well.

### DETAILED DESCRIPTION

The computing environment 100 of FIG. 1 according to an embodiment of the subject matter disclosed herein may comprise various combinations of components configured to facilitate the generation and assembly of audio-visual content. The content assembly and generation engine 110 may be communicatively coupled to a database 120 that stores audio assets, video assets, character definitions, and script data. The engine 110 may further communicate with a modeling and prediction computing block 130 that processes audience interaction data and generates content modification parameters. A production engine 140 may be integrated with the content assembly and generation engine 110 to render the AV-content presentations based on parsed directives and assembled assets. The reporting engine 150 may track usage of measured elements throughout the content generation process and may generate usage reports for royalty tracking purposes. The computing environment 100 may also include a network interface 160 that enables communication with external systems and third-party computing devices 170.

The content assembly and generation engine 110 according to an embodiment of the subject matter disclosed herein may operate in various configurations depending on the specific implementation requirements. The engine 110 may function as a standalone system that processes all content generation tasks internally. Alternatively, the engine 110 may be distributed across multiple computing nodes where different components handle specific processing tasks. The database 120 may be implemented as a centralized storage system or as a distributed database architecture. The modeling and prediction computing block 130 may be integrated within the same hardware infrastructure as the engine 110 or may be deployed as a separate service accessible through application programming interfaces. The production engine 140 may operate in real-time to generate content during live consumption or may pre-render content for subsequent distribution. The reporting engine 150 may function continuously to monitor asset usage or may operate in batch mode to generate periodic reports.

The third-party computing devices 170 of FIG. 1 according to an embodiment of the subject matter disclosed herein may comprise various types of external systems that provide input data or consume generated content. A first type of third-party computing device 170 may be a content consumption device such as a streaming media player, smart television, mobile device, or personal computer that receives and displays the AV-content presentations. A second type of third-party computing device 170 may be an audience interaction device that captures user input during content consumption, such as a mobile application that receives voting data, preference selections, or real-time feedback from viewers. A third type of third-party computing device 170 may be a content provider system that supplies audio assets, video assets, or script data to the content assembly and generation engine 110 through application programming interfaces. A fourth type of third-party computing device 170 may be an analytics platform that receives usage data and audience interaction metrics from the reporting engine 150 for further analysis and reporting purposes.

The third-party computing devices 170 according to an embodiment of the subject matter disclosed herein may also include systems that facilitate content generation through external data sources. A social media platform may serve as a third-party computing device 170 that provides trending topics, user preferences, or demographic data to influence content generation directives. A weather service system may function as a third-party computing device 170 that supplies real-time environmental data to modify scene settings or character behaviors in the generated content. A news aggregation service may operate as a third-party computing device 170 that delivers current events data to inform script generation and storyline development. An advertising platform may be implemented as a third-party computing device 170 that communicates advertisement insertion points and sponsored content requirements to the production engine 140 during the content assembly process.

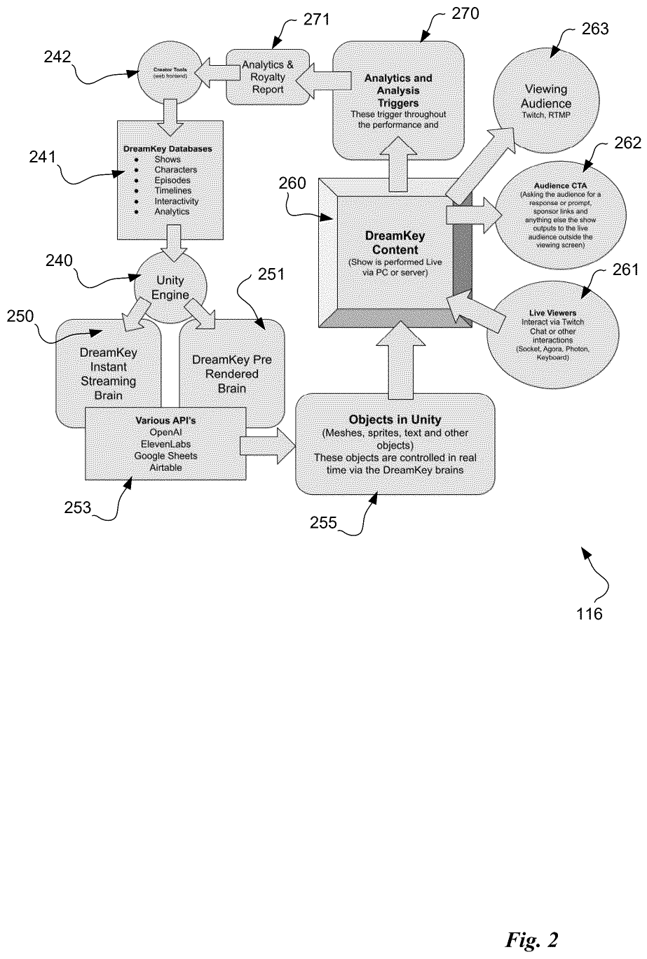

FIG. 2 is a block diagram of the content assembly and generation engine 116 of FIG. 1 illustrating the architecture and flow of data according to an embodiment of the subject matter disclosed herein. The content assembly and generation engine 116 (e.g., the “DreamKey™ brain” hereinafter) allows for the performance of fully produced multi-character content with sound design, animation performance, dialogue, and camera direction created in real-time from multiple sources, including the live viewing audience. The DreamKey™ brain 116 is a set of modules allowing a user to integrate this approach into a generation engine 240 (such as a specific 3^{rd} party rendering engine like Game Unity™), and the like. External tools 241 (e.g., external to the generation engine 240) include various sets of databases communicatively coupled to a web-based frontend 242 that a user may engage to create shows. These external tools 241 include databases for shows, characters, episodes, timelines, interactivity, analytics, and the like. Inside the front end 242, a credentialed user may edit these databases and parameters.

For example, a credentialed user may edit and influence the show database by altering specific database entries (and rules therein) for show descriptions, overall show vibe, show Compensations, show lengths; allowed content (e.g., swear-words, violent adult themes, and the like), other show settings (e.g., API keys, special commands), sound effects libraries, music libraries, location libraries, and external content (e.g., 3^{rd} party video and imagery rendered). As another example, a credentialed user may edit and influence the character database by altering specific database entries (and rules therein) for physical attributes. psychological attributes, voice controls (e.g., TTS generation), emotion libraries, animation libraries, characters in the show, and timelines in the show.

As further examples, a credentialed user may influence any interactive elements in the show. That is, any interactive elements that might be built into the show may be associated manually inside the generation engine 240 to communicate with the DreamKey™ brain 116. Additionally, episodes may be associated with a main level of one or more shows. With this association, episodes may act as a prompt that controls an overall plot or events that happen in the show. The plot may drive a timeline; however, these elements are not necessarily required for every show. A timeline may be controlled by form and flow of the show per event. For example, a gameshow timeline may be an introduction, round 1, commercial break, round 2, talk to contestants, round 3, bonus round, and concluding scene. Another example of a more narrative timeline would be a hero's journey story form. Some shows may call for special commands, for example, image generation, image analysis, and live audience sentiment. This feature may be open-ended allowing the user to insert custom elements into a show for greater flexibility and control.

Once all desired inputs are configured, each input may be triggered to be rendered and performed by the DreamKey™ brain 116. In this embodiment, there are two main rendering engines, the instant streaming brain 250 and the pre-rendered brain 251. Both brains 250 and 251 receive inputs from the generation engine 240 and function slightly differently. The instant streaming brain 250 is more flexible and uses a TTS model that is less performative while the pre-rendered brain 251 renders about half an episode before performing. The pre-rendered brain 251 is slower and less flexible, but audio content can be more performative. Generally speaking, a combination of influences of the two rendering engines 250 and 251 is desired for a balanced performance between spontaneity and chosen content.

At this point, the rendering engines 250 and 251 are either processing a prewritten script or generating one based on the rules of the show. In one embodiment, various 3^{rd}-party APIs 253 may be called to influence the rendering. For example, a large language model (LLM) such as OpenAI™ (or any other LLM model), may take in a prompt and return a script in a usable Dream Key™ format. Further, optional LLM agents and/or API-called functionality with specific skill sets may be used for aspects like camera shots, script punch up, sound design and the like. These agents Or API-called functionality includes OpenAI™, ElevenLabs™, Google Sheets™, and Airtable™.

Once an initial portion of the show is generated, it is passed to an object rendering module 255 that puts the portion into a format that may performed by a performer module 260. As the show begins, a reference script is now added to the rendering module to help guide the renderer. As performance is happening, viewers 263 may view the rendered and performed section while the next portions of the show are being pre-rendered by the pre-rendering engine 251 and as those are completed they are passed to the performance module 260 and are performed in the proper order. Once the show has completed all the timeline portions, the show is complete. Sometimes, the rendering engines 250, 251 may wait for inputs like audience input 262 or a specific part of the show to be performed before rendering a section. In this case, the rendering engines 250, 251 either pause rendering until receiving the needed input or render sections that are not dependent on uncollected inputs. Additionally, the system may incorporate audience interaction 261. Audience interaction may be via twitch text or any string input and may then influence various elements of the content in a feed-forward manner.

As previously mentioned above, the rendered show may be performed via a performance module 260. At the start of the scene, the performance module 260 pulls in additional elements for a show such as background or setting. The performance module 260 then places the proper characters in the scene based on script, plot, and timeline rules in the scene. The performance module 260 interprets script from beginning to end sending commands to the characters in the scene as the performance unfolds.

Throughout the creation, rendering and performance of a show, specific measured elements may be associated with previously agreed-upon treatments during production. For example, measured elements can be (but are not limited to) music, audio samples, voice usage, character usage, art and characters on screen, character personality elements. An analytics engine 270 tracks use of these triggering measured elements. These triggers are flexible and can be attached to any object or module. A team creating the show decides on what specific measured elements are triggering, and, with this analytical tracking in place for elements used, a report of usage may be generated by a reporting engine 271. One such use of this usage report may be as a royalty report so that owners of copyrighted elements may be given proper agreed-upon royalties.

According to other embodiments of the subject matter disclosed herein, the system architecture illustrated in FIG. 2 may be configured with various combinations of components to achieve different operational capabilities. The content assembly and generation engine 200 may include a content library 210 that may be communicatively coupled to a production engine 220. The production engine 220 may be further coupled to a modeling and prediction computing block 230. The modeling and prediction computing block 230 may receive inputs from an audience interaction module 240. The audience interaction module 240 may be configured to capture real-time data during content consumption. A reporting engine 250 may be coupled to the production engine 220 to track asset usage. The reporting engine 250 may generate usage reports for measured elements. A script generation module 260 may be coupled to the production engine 220. The script generation module 260 may receive inputs from external application programming interfaces 270. The external application programming interfaces 270 may provide content generation parameters. A character definition module 280 may be coupled to the content library 210. The character definition module 280 may store physical attributes, psychological attributes, and voice control parameters for each character.

According to an embodiment of the subject matter disclosed herein, alternative configurations of the system of FIG. 2 may be implemented to support different content generation workflows. The content library 210 may be subdivided into an audio asset repository 212 and a video asset repository 214. The audio asset repository 212 may store music files, sound effects, and voice samples. The video asset repository 214 may store visual elements, character animations, and background scenes. The production engine 220 may include a rendering module 222 and a synchronization module 224. The rendering module 222 may process audio and video assets to generate output content. The synchronization module 224 may align audio content with corresponding video assets. The modeling and prediction computing block 230 may incorporate a machine learning processor 232 and a content modification analyzer 234. The machine learning processor 232 may execute trained models for content generation. The content modification analyzer 234 may process audience interaction data to identify modification parameters. The reporting engine 250 may include a usage tracking module 252 and a royalty calculation module 254. The usage tracking module 252 may monitor consumption of measured elements. The royalty calculation module 254 may compute compensation based on asset usage.

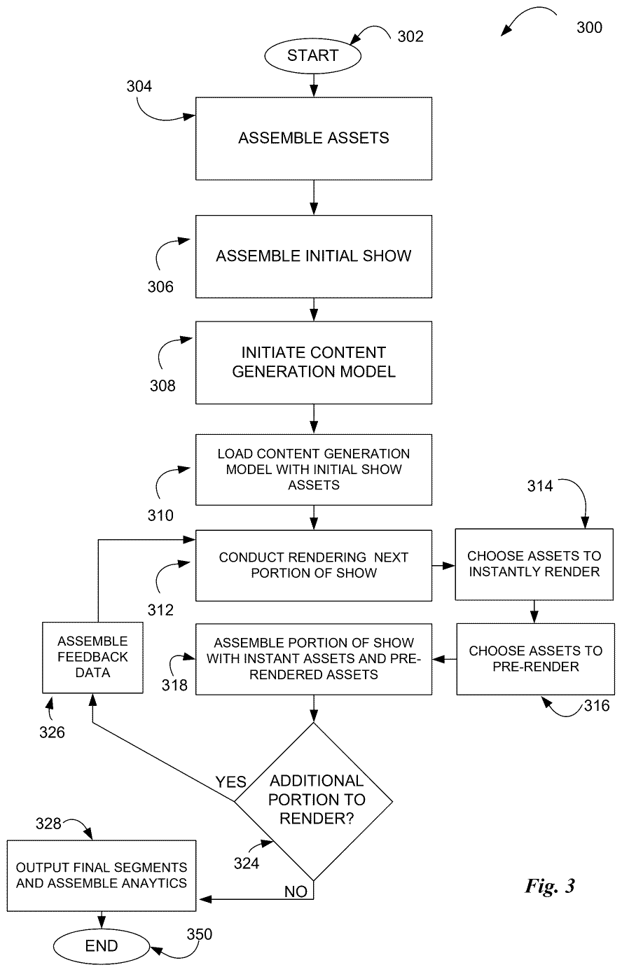

FIG. 3 is a flow chart illustrating exemplary computer-based method for content assembly and generation according to an embodiment of the subject matter disclosed herein. The method may begin at step 300, where the process may be initiated. Step 302 may involve assembling a plurality of audio assets. The audio assets may comprise pre-recorded sound files, music tracks, voice recordings, sound effects, or other auditory elements. Each audio asset may be stored in a digital format suitable for processing by one or more processors. The audio assets may be retrieved from one or more databases or storage locations. The assembly process may include organizing the audio assets according to metadata tags, categories, or other classification schemes.

Step 304 may involve assembling a plurality of video assets. The video assets may comprise image files, video clips, animated sequences, graphical elements, or other visual components. Each video asset may be stored in a digital format compatible with video processing systems. The video assets may be retrieved from one or more repositories or content libraries. The assembly process may include cataloging the video assets based on attributes such as resolution, duration, subject matter, or visual characteristics.

Step 306 may involve receiving a first set of directives for content generation. The first set of directives may comprise instructions, parameters, or specifications that guide the generation of audio-visual content. The directives may be received from a user interface, an application programming interface, or an automated system. The directives may specify content requirements such as theme, tone, duration, or target audience. The directives may also include constraints related to content restrictions or compliance requirements.

Step 308 may involve parsing the plurality of audio assets, the plurality of video assets, and the first set of directives to generate a first rendition of an AV-content presentation. The parsing process may include analyzing the directives to determine which audio and video assets may be suitable for inclusion in the presentation. The parsing may involve matching asset characteristics with directive requirements. The generation of the first rendition may include combining selected audio assets with selected video assets in a synchronized manner. The first rendition may be rendered as a complete audio-visual presentation ready for consumption.

Step 310 may involve receiving a second set of directives corresponding to consumption of the first rendition. The second set of directives may be generated based on feedback, interaction data, or consumption patterns observed during presentation of the first rendition. The second set of directives may be received from audience members, monitoring systems, or analytical engines. The directives may reflect preferences, engagement levels, or modification requests. The second set of directives may differ from the first set of directives in one or more parameters.

Step 312 may involve generating a second rendition of the AV-content presentation that may be different from the first rendition. The generation of the second rendition may be based on the second set of directives. The second rendition may include different audio assets, different video assets, or a different arrangement of assets compared to the first rendition. The modifications may be implemented to improve audience engagement, address feedback, or adapt to changing conditions. The second rendition may be rendered and prepared for subsequent consumption.

Step 314 may involve determining whether additional renditions may be required. The determination may be based on ongoing consumption data, audience interaction, or predefined iteration criteria. If additional renditions may be required, the process may return to step 310 to receive further directives. If no additional renditions may be required, the process may proceed to step 316.

Step 316 may involve finalizing the AV-content presentation. The finalization may include storing the final rendition, distributing the content to consumption platforms, or archiving the presentation for future use. The finalization may also include generating reports related to asset usage, audience engagement, or performance metrics. The process may then proceed to step 318, where the method may terminate.

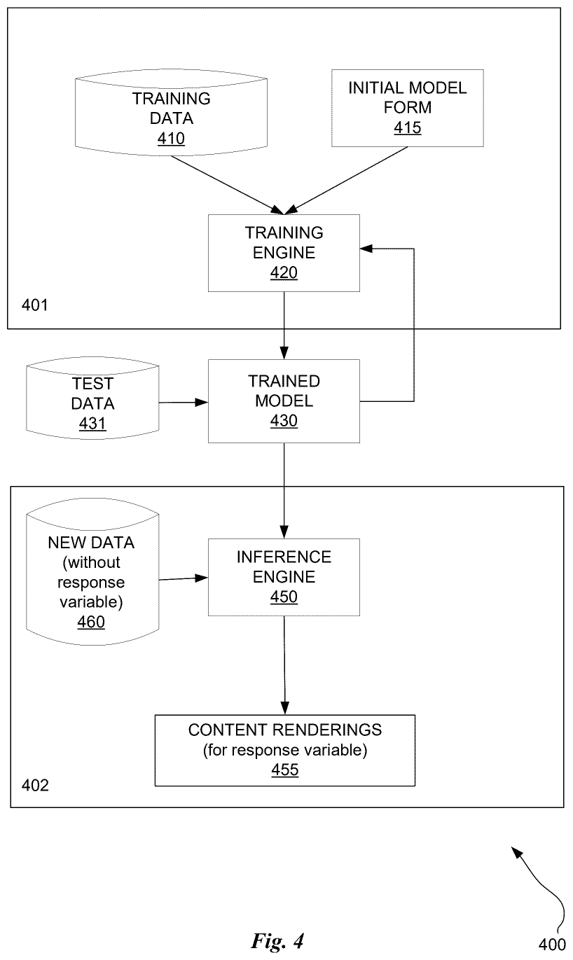

FIG. 4 is a block diagram of a modelling and content generation computing block of the computing environment of FIG. 1 according to an embodiment of the subject matter disclosed herein. In this block diagram 400, some modules may represent functional activities, such as data collection and training, but this diagram is, nevertheless, presented in a block diagram format to convey the functional aspects of the overall modelling and content generation computing block 400. Thus, in FIG. 4, a first aggregated set of functions includes the upper half 401 of the diagram where a trained generative model 430 is first established and trained for use in making content generations. Once the trained model 430 is established, the lower half 402 of the block diagram of FIG. 4 focuses on generating initial content to be checked against desired generation and audience reaction as well as new content generation based on new data collected.

In the upper half 401, training data 410 may be drawn from an established database of content input data along with an initialized model form 415 to a training engine 420. The training data 410 may include actual collected data from rendered content. Further, the training data 410 may be created based on learned judgment of best content generation practices. Further, the model form 415 may be pre-established using best modeling practices such that the model form 415 includes known influences for, for instance, historical reaction data, human behavioral data, desired targeting strategy, and the like. As the initial training data 410 may also include outcomes and other measurable performance data, a training engine 420 may begin to “train” the model form 415 by identifying specific data correlations and data trends that affect the measurable outcomes from the training data 415. For example, a correlation may be drawn between optimal music placement (a predicted content rendering) and positive audience feedback (an input). As all relevant and/or influential correlations are determined by the training engine 420, a trained model 430 is established. The trained model 430 may be further updated and/or improved by inputting test data 431 and iteratively continuing to train the trained model 430 through a feedback loop.

With the trained model 430 established, an inference engine 450 may then utilize the trained model 430 along with newly collected input data 460. That is, a manager may wish to use the system to predict optimal usage of music content based on current and previous collected and assimilated data as well as based on initial predictions using newly collected data. Therefore, the manager may present new data 460 in the form of music streaming sales in proximity to the performance. The new data 460 is used by the inference engine 450 that employs use of the trained model 430 to generate one or more content generation parameters 455. In continuing the example from above, the content generation parameter 455 may be an optimal amount of time for the music to be rendered in a show given the machine-learned trained model 430 and the new data 460 presented.

According to an embodiment of the subject matter disclosed herein, the training engine 404 may implement a feedback loop mechanism to iteratively refine the trained model 406. The feedback loop may begin when the trained model 406 generates output content based on input parameters received from the content assembly and generation engine 200. The output content may be evaluated against predetermined quality metrics stored within the training engine 404. The quality metrics may include measures of audience engagement, content coherence, character consistency, and adherence to specified directives. The evaluation results may be fed back into the training engine 404 to adjust model parameters.

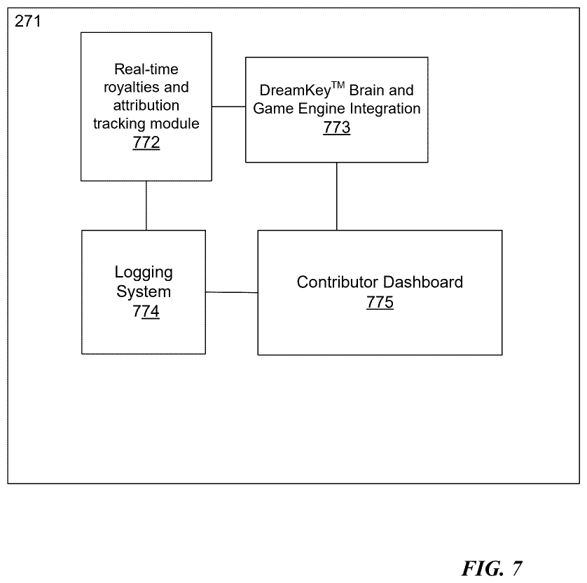

According to an embodiment of the subject matter disclosed herein, the training engine 404 may receive performance data from the reporting engine 700 (FIG. 7) during the feedback loop process. The performance data may include audience interaction metrics collected during consumption of generated content. The training engine 404 may analyze the performance data to identify patterns that correlate with successful content generation. The identified patterns may be used to update weighting factors within the trained model 406. The updated weighting factors may influence subsequent content generation operations. The feedback loop may continue until convergence criteria are satisfied.

According to an embodiment of the subject matter disclosed herein, the training engine 404 may incorporate error correction mechanisms within the feedback loop. The error correction mechanisms may compare generated content against reference content to identify deviations. The deviations may be quantified using loss functions that measure differences between expected and actual outputs. The loss functions may be minimized through gradient descent optimization techniques applied to the trained model 406. The optimization process may adjust neural network weights within the trained model 406. The adjusted weights may improve the accuracy of subsequent content generation operations.

According to an embodiment of the subject matter disclosed herein, an example training feedback loop may be implemented for refining character voice generation. The trained model 406 may initially generate voice audio for a character based on voice control parameters received from the character definition module. The generated voice audio may be evaluated against reference voice samples stored in the audio asset library 202. The training engine 404 may calculate a similarity score between the generated voice audio and the reference voice samples. The similarity score may be compared against a threshold value to determine whether the generated voice audio meets quality standards.

According to an embodiment of the subject matter disclosed herein, when the similarity score falls below the threshold value in the example training feedback loop, the training engine 404 may identify specific acoustic features that contribute to the deviation. The acoustic features may include pitch variation, speaking rate, emotional tone, and pronunciation accuracy. The training engine 404 may adjust parameters within the trained model 406 that control these acoustic features. The adjusted parameters may be applied to generate a revised version of the voice audio. The revised voice audio may be re-evaluated against the reference voice samples to calculate an updated similarity score.

According to an embodiment of the subject matter disclosed herein, the example training feedback loop may continue through multiple iterations until the similarity score exceeds the threshold value. Each iteration may produce incremental improvements in the quality of the generated voice audio. The training engine 404 may store the final parameter values that produced the acceptable voice audio. The stored parameter values may be used as starting points for future voice generation operations involving similar character types. The feedback loop process may be applied across multiple content generation tasks to continuously improve the performance of the trained model 406.

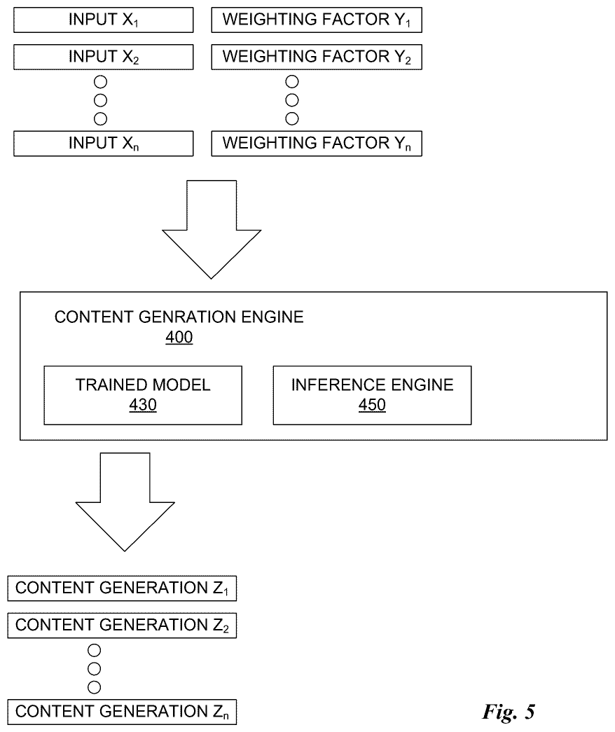

FIG. 5 is a hybrid block diagram and flow chart illustrating inputs, factors and weighting influences for generating produced content in the system of FIG. 2 according to an embodiment of the subject matter disclosed herein.

In general, all inputs that may be used to determine one or more outcomes or generated content are illustrated in a top portion of FIG. 5, while all content generation are illustrated in a bottom portion of FIG. 5. FIG. 5 illustrates one or more algorithms that may be realized during the establishment of the trained model 430 whereby the content generation 116 may establish specific content generation Z₁-Zₙ based on new data through its inference engine 450. That is, given inputs X₁-Xₙ, each with corresponding weighting factors Y₁-Yₙ, the inference engine 450 will utilize the trained model 430 to generate content Z₁-Zₙ.

According to an embodiment of the subject matter disclosed herein, FIG. 5 illustrates a hybrid block diagram and flow chart depicting inputs, factors, and weighting influences for generating produced content. The input determination process may begin with the collection of raw input data from multiple sources as shown in block 502. Each input source may be assigned a preliminary weight value stored in database 504. The weighting of inputs may be dynamically adjusted based on historical performance metrics retrieved from analytics module 506. A weighting algorithm executed by processor 508 may calculate adjusted weight values for each input based on predefined criteria. The adjusted weight values may be applied to the corresponding inputs to generate weighted input data in block 510. The weighted input data may then be forwarded to content generation module 512 for further processing.

According to an embodiment of the subject matter disclosed herein, the output determination process in FIG. 5 may commence with the generation of preliminary output content by content generation module 512. The preliminary output content may be evaluated by quality assessment module 514 to determine compliance with output standards. Each output element may be assigned a quality score by scoring engine 516. The quality scores may be used to calculate output weight values in weighting processor 518. The output weight values may be stored in output weight database 520. The weighted output data may be transmitted to distribution module 522 for delivery to end users.

According to an embodiment of the subject matter disclosed herein, a weighted input example may involve the processing of audience demographic data as one input source. The audience demographic data may be assigned an initial weight of 0.3 in the weighting system. Historical engagement data may indicate that demographic factors correlate strongly with content consumption patterns. The weighting algorithm may increase the demographic data weight to 0.5 based on this correlation. The weighted demographic input may then influence the selection of character attributes in the content generation process. The adjusted weighting may result in content that may be more closely aligned with audience preferences.

According to an embodiment of the subject matter disclosed herein, a weighted outcome example may involve the measurement of audience retention rates as an output metric. The retention rate data may be assigned an initial outcome weight of 0.4 in the evaluation system. The quality assessment module 514 may determine that retention rates exceed target thresholds by twenty percent. The weighting processor 518 may increase the outcome weight to 0.6 to reflect the superior performance. The weighted outcome data may be fed back to input determination module 502 to influence future content generation decisions. The feedback loop may enable continuous optimization of content production parameters.

According to an embodiment of the subject matter disclosed herein, the interaction between weighted inputs and weighted outcomes may create a dynamic adjustment mechanism within the system of FIG. 5. Input weights from database 504 may be modified based on outcome weights from database 520. A correlation analysis module 524 may identify relationships between specific input factors and output performance metrics. The identified correlations may be used to refine the weighting algorithms in both processor 508 and processor 518. The refined algorithms may generate more accurate weight assignments for subsequent content generation cycles. The iterative refinement process may enhance the overall effectiveness of the content assembly and generation engine.

According to an embodiment of the subject matter disclosed herein, the combined influence of weighted inputs and weighted outcomes may be illustrated through a specific operational scenario. A music library input may be assigned a weight of 0.25 based on initial parameters. The corresponding output metric measuring audience emotional response may be assigned an outcome weight of 0.35. Analysis may reveal that specific music selections correlate with elevated emotional response scores. The input weight for the music library may be increased to 0.40 to reflect this correlation. Simultaneously, the outcome weight for emotional response may be adjusted to 0.50 to emphasize this performance indicator. The dual adjustment may result in content that may be optimized for both input resource allocation and output performance objectives.

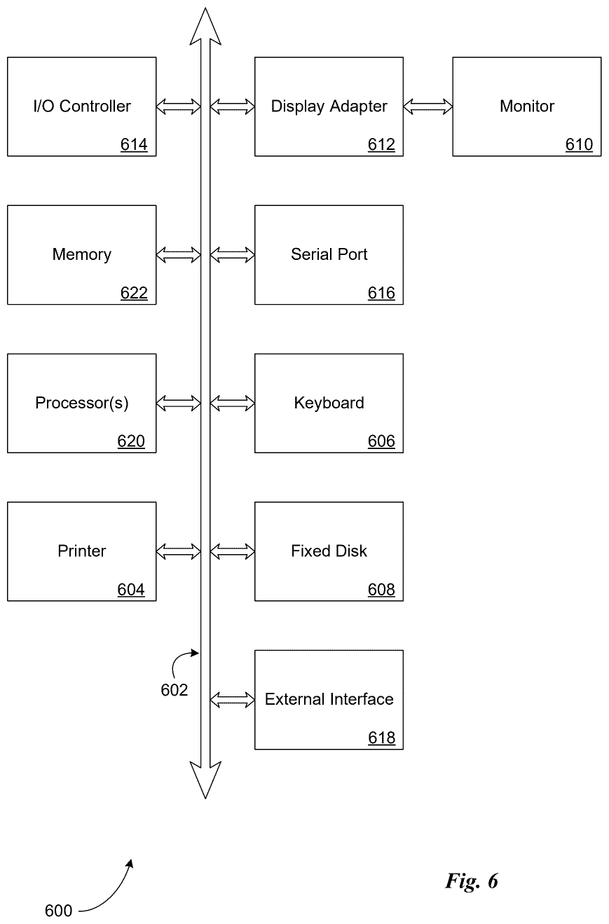

FIG. 6 and the following discussion are intended to provide a brief, general description of a suitable computing environment in which the subject-matter disclosed herein may be implemented. Although not required, aspects of the subject matter disclosed herein will be described in the general context of computer-executable instructions, such as program modules, being executed by a personal computer. Generally, program modules include routines, programs, objects, components, data structures, and the like, which perform particular tasks or implement particular abstract data types. Such program module may be embodied in both a transitory and/or a non-transitory computer-readable medium having computer-executable instructions. Moreover, those skilled in the art will appreciate that the invention may be practiced with other computer system configurations, including hand-held devices, cellular or mobile telephones, multiprocessor systems, microprocessor-based or programmable consumer electronics, network PCs, minicomputers, mainframe computers, and the like. The invention may also be practiced in distributed computing environments where tasks are performed by remote processing devices that may be linked through a communications network. In a distributed computing environment, program modules may be located in both local and remote memory storage devices.

FIG. 6 is a block diagram of a generic computing device 600 for realizing systems and methods for machine-learning influenced content production and strategies according to one or more embodiments of the subject matter disclosed herein. It may include the system, apparatus, methods, processes, functions, and/or operations for enabling efficient configuration and presentation of a user interface to a user, based on the user's previous behavior, and may be wholly or partially implemented in the form of a set of instructions executed by one or more programmed computer processors, such as a central processing unit (CPU) or microprocessor. Such processors may be incorporated in an apparatus, server, client or other computing or data processing device operated by, or in communication with, other components of the system. FIG. 6 illustrates elements or components that may be present in a computer device or system 600 configured to implement a method, process, function, or operation in accordance with an embodiment. The subsystems shown in FIG. 6 are interconnected via a system bus 602. Additional subsystems include a printer 604, a keyboard 606, a fixed disk 608, and a monitor 610, which is coupled to a display adapter 612. Peripherals and input/output (I/O) devices, which couple to an I/O controller 614, can be connected to the computer system by any number of means known in the art, such as a serial port 616. For example, the serial port 616 or an external interface 618 can be utilized to connect the computer device 600 to additional devices and/or systems not shown in FIG. 6, including a wide area network (such as the Internet), a mouse input device, and/or a scanner. The interconnection via the system bus 602 allows one or more processors 620 to: communicate with each subsystem, control the execution of instructions that may be stored in a system memory 622 and/or the fixed disk 608, and to exchange information between subsystems. The system memory 622 and/or the fixed disk 608 may represent any tangible computer-readable medium.

The subject matter described herein can be implemented in software in combination with hardware and/or firmware. For example, the subject matter described herein may be implemented in software executed by one or more processors. In one exemplary implementation, the subject matter described herein may be implemented using a non-transitory computer-readable medium having stored thereon computer executable instructions that when executed by the processor of a computer control the computer to perform steps. Exemplary computer-readable media suitable for implementing the subject matter described herein include non-transitory computer-readable media, such as disk memory devices, chip memory devices, programmable logic devices, and application-specific integrated circuits. In addition, a computer-readable medium that implements the subject matter described herein may be located on a single device or computing platform or may be distributed across multiple devices or computing platforms.

The system may use a bus 602 that can be any of several types of suitable bus structure(s) including the memory bus or memory controller, a peripheral bus or external bus, and/or a local bus using any suitable variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

FIG. 7 is a block diagram of the reporting engine of FIG. 2 showing integrated components of this module according to an embodiment of the subject matter disclosed herein. As discussed above, the reporting engine 771 may generate a usage report. One such use of this usage report may be as a royalty report so that owners of copyrighted elements may be given proper agreed-upon royalties. As royalty-based assets are assembled and performed, a real-time royalties and attribution tracking module 772 within the reporting engine 771 may initiate, at pre-determined intervals (e.g., once a week, once a month, or the like), payments to content owners based upon accumulated usage of royalty-bearing assets.

The real-time royalties and attribution tracking module 772 for AI-generated live content is designed to provide an automated, transparent, and real-time solution for tracking and distributing royalties and residuals to contributors of AI-assisted or AI-generated livestreamed content. The system ensures that every creative element—such as characters, props, backgrounds, and other assets—is properly attributed to its respective creators while dynamically calculating and distributing payments in accordance with predefined contractual agreements.

Another sub-module may include a DreamKey™ Brain and Game Engine Integration block 773. This block 773 operates within the DreamKey™ Brain, which is responsible for AI-assisted or AI-generated livestreamed content. While primarily built to function in conjunction with a rendering engine 740, it is designed to be compatible with any game engines through an adaptable architecture. As assets (characters, props, environments, sound elements, and the like) are used within a live broadcast, the block sends real-time notifications via webhooks to track usage. Further, each time an asset appears on-screen, a webhook pings the block to generate a log entry within the attribution database. This process is fully automated, ensuring that all contributions are tracked without requiring manual input in real-time. A logging system 774 timestamps each occurrence and associates it with the appropriate contributor based on metadata embedded within the asset. Further yet, predefined contracts and revenue distribution may be established. Contributor royalties may be determined by pre-established agreements with executive producers and production teams. These agreements define how revenue is allocated among writers, artists, and voice actors based on their contributions to specific assets. The system dynamically calculates earnings based on the predefined allocation model, ensuring fair and transparent distribution. Further, Automated payments may or may not be part of an overall system at the time of publication. In other embodiments, payments are tracked and paid out at regular intervals, such as monthly or quarterly.

The engine 771 further includes a contributor dashboard 775 providing each contributor with a dashboard for viewing timestamped logs of every time their work appears in a broadcast, tracking real-time earnings and residuals generated from content usage, disputing misattributions or incorrect allocations, accessing detailed revenue breakdowns and historical data, and receive direct deposit payments for royalties (pending integration of payment processing capabilities). The contributor dashboard 775 may further include executive producer controls: The dashboard 775 also offers a backend interface for executive producers and production teams, allowing them to adjust royalty allocations as needed based on evolving contributions or deprecated elements, review and resolve contributor disputes, and oversee financial distributions and ensure contractual compliance. Further, the dashboard may have additional back-up features to checking and ensuring content use in productions. Errors may be identified and remedied on a semiregular basis or in real-time.

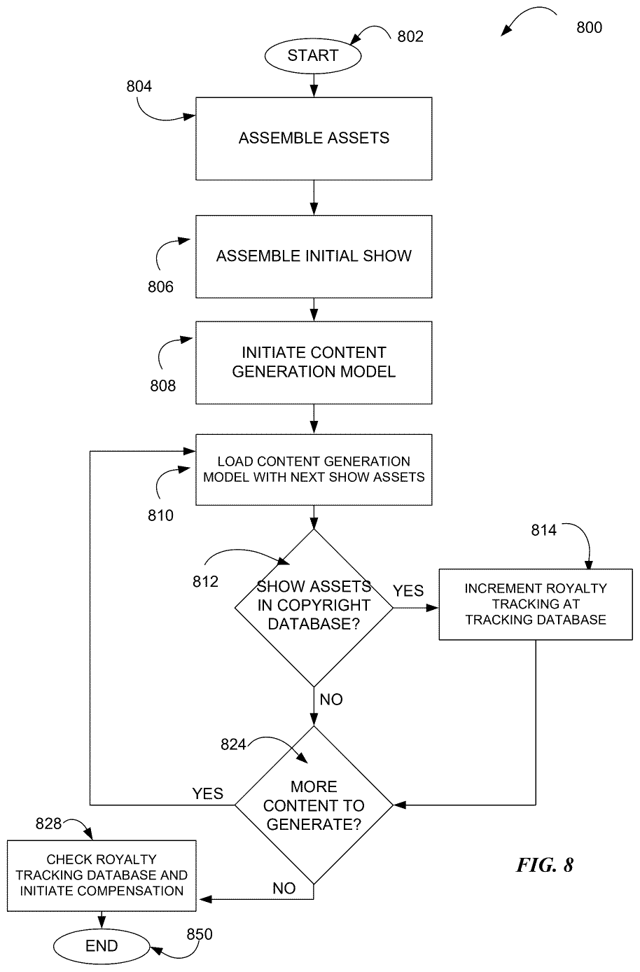

To prevent fraudulent claims and ensure data integrity, the engine 771 exclusively logs information native to the show being watched. All attribution data is generated in real time, making falsification extremely difficult. Further, other embodiments of the engine 771 may include cryptographic verification or blockchain-based tracking to further enhance security. Aspects of these methods are further detailed next with respect to FIG. 8.

FIG. 8 is a flow chart illustrating exemplary computer-based method for royalty tracking during content assembly, generation, and performance according to an embodiment of the subject matter disclosed herein. In one embodiment, the method includes one or more steps depicted in FIG. 8. The method may begin at step 800 where the process may be initiated. The method may proceed to step 802 where a plurality of content assets may be assembled. The plurality of content assets may include audio assets, video assets, image assets, text assets, or combinations thereof. Each content asset may be associated with metadata that may identify ownership information, licensing terms, usage restrictions, or royalty requirements.

The method may advance to step 804 where character definitions may be received. Each character definition may include physical attributes, psychological attributes, voice parameters, or behavioral characteristics. The character definitions may be stored in a database and may be associated with specific content assets. The voice parameters may include pitch, tone, speed, accent, or emotional characteristics that may be used to generate synthesized speech for the character.

At step 806, show parameters may be received. The show parameters may define the overall structure and constraints for the content to be generated. The show parameters may include show description, show vibe, show length, content restrictions, genre specifications, target audience demographics, or thematic elements. The show parameters may also specify libraries of sound effects, music, locations, or other resources that may be available for use in the generated content.

The method may proceed to step 808 where a script may be generated. The script may be generated based on the character definitions and show parameters received in previous steps. The script generation may utilize a large language model or other artificial intelligence system. The script may include dialogue for multiple characters, stage directions, scene descriptions, or timing information. The script may be formatted to facilitate subsequent processing steps.

At step 810, the script may be parsed to identify content elements. The parsing process may extract character dialogue, scene descriptions, action sequences, or other elements from the script. Each identified element may be tagged with metadata that may facilitate subsequent processing. The parsing may also identify relationships between elements, such as which characters appear in which scenes or which dialogue lines belong to which characters.

The method may advance to step 812 where audio content may be generated. The audio content generation may utilize text-to-speech models to convert character dialogue into synthesized speech. The text-to-speech models may apply voice parameters from the character definitions to produce speech that may match the intended characteristics of each character. The audio content generation may also include selection or generation of background music, sound effects, or ambient audio.

At step 814, video content may be generated or selected. The video content may include animated characters, background scenes, visual effects, or other visual elements. The video content may be generated using computer graphics techniques, selected from pre-existing asset libraries, or obtained from external sources. The video content may be synchronized with the audio content generated in the previous step.

The method may proceed to step 816 where asset usage may be tracked. The asset usage tracking may monitor which content assets are used in the generated content and to what extent each asset may be used. The tracking may record usage of music, audio samples, voice models, character designs, artwork, personality elements, or other measurable elements. Each usage instance may be recorded with timing information, duration, or other quantitative measures.

At step 818, royalty obligations may be calculated. The royalty calculations may be based on the asset usage tracked in the previous step and licensing terms associated with each content asset. The calculations may determine monetary amounts owed to rights holders for each asset used. The royalty calculations may account for different licensing models, such as per-use fees, time-based fees, or revenue-sharing arrangements.

The method may advance to step 820 where a usage report may be generated. The usage report may identify each content asset used in the generated content and the corresponding royalty obligations. The usage report may include detailed breakdowns by asset type, rights holder, or time period. The usage report may be formatted for distribution to rights holders, payment processing systems, or accounting systems.

At step 822, the generated content may be assembled into a final rendition. The assembly process may combine the audio content and video content into a synchronized audiovisual presentation. The assembly may apply timing adjustments, transitions, or effects to produce a cohesive presentation. The final rendition may be encoded in a format suitable for distribution or playback.

The method may proceed to step 824 where the final rendition may be distributed or presented to an audience. The distribution may occur through streaming platforms, broadcast systems, or other delivery mechanisms. During or after presentation, audience interaction data may be collected. The audience interaction data may include viewing metrics, engagement indicators, or explicit feedback from audience members.

At step 826, the audience interaction data may be analyzed. The analysis may identify patterns, preferences, or trends in audience behavior. The analysis may determine which content elements generated positive or negative responses. The analysis results may be used to inform subsequent content generation processes.

The method may advance to step 828 where a determination may be made whether to generate additional content. If additional content may be generated, the method may return to an earlier step to create a new rendition. The new rendition may incorporate modifications based on the audience interaction data analyzed in the previous step. If no additional content may be generated, the method may proceed to step 830 where the process may terminate.

The method illustrated in FIG. 8 may enable automated tracking of asset usage and calculation of royalty obligations during generative content production. The integration of royalty tracking into the content generation workflow may ensure that rights holders may be properly compensated for use of their assets. The method may support complex licensing arrangements and may accommodate multiple rights holders for different assets used in a single piece of generated content.

The systems and methods described herein are designed to function across multiple streaming platforms, including YouTube™, Twitch™, and proprietary livestreaming services. Additionally, it can be adapted for use in traditional television broadcasts should industry demand arise. The tracking mechanism is agnostic to the distribution platform, ensuring widespread applicability in various entertainment and media sectors. While the system is primarily focused on AI-generated television, film, e-sports, and streaming content, it has broader applications in other creative industries. For example, the system may track the use of sampled music ensuring appropriate royalties for artists. In other embodiments, the AI-engine may compose dynamically and generate new copyrighted material based on an author's input—also assets that can tracked and the properly accounted for. The system may assist developers and content creators with tracking and compensation regarding asset contributions within game development and live game streaming. To enhance interoperability with external platforms, the system includes a suite of APIs that allow companies to import tracking data into their own databases. This enables third-party platforms to integrate a real-time attribution system with existing financial and rights management systems, further expanding the adoption of transparent royalty tracking.

The Real-Time Royalties and Attribution Tracking System for AI-Generated Live Content provides an innovative solution to one of the most pressing issues in the AI-assisted content space. Namely, a fair and transparent attribution of creative contributions. By leveraging real-time logging, automated revenue distribution, and a robust dashboard for contributors and executives, the system ensures that all stakeholders receive fair compensation while eliminating the opacity and inefficiencies present in traditional royalty models. The royalty tracking model can be modified for different industries, such as video games, interactive advertising, or virtual concerts. The system can integrate machine learning models to refine attribution weight over time. Audience influence tracking can be customized for livestream viewership, voting, or AI-assisted crowd-sourced storytelling.

For example, if 100 people are watching, an asset owner may be paid a first level of royalty, but if 100,000 people are watching, the asset owner may receive a higher royalty rate. Thus, compensation and rates may be adjustably weighted based on viewership.

The above-described embodiments exhibit may advantages including real-time tracking to eliminate manual royalty disputes, ensuring fair attribution in constantly evolving AI-generated content, a system that is transparent, automated, and scalable for different content industries, and a system that is customizable royalty structures gives showrunners or producers flexibility for different creator models.

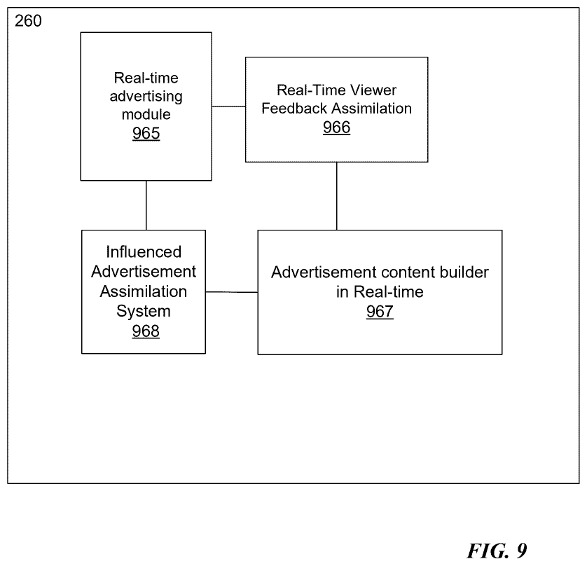

FIG. 9 is a block diagram of the production engine 260 of FIG. 2 showing integrated components of this module according to an embodiment of the subject matter disclosed herein. As discussed above, the production engine 260 may generate a streaming content in real-time that includes advertisements with a stream. One such use of this usage advertisement engine may be as a revenue generation source by integrating advertising into produced streams and may do so based on influence from multiple users such that specific copyrighted elements may be used within a produced stream in real-time. As royalty-based assets are assembled and performed, a real-time royalties and attribution tracking module may track usage for royalty purposes.

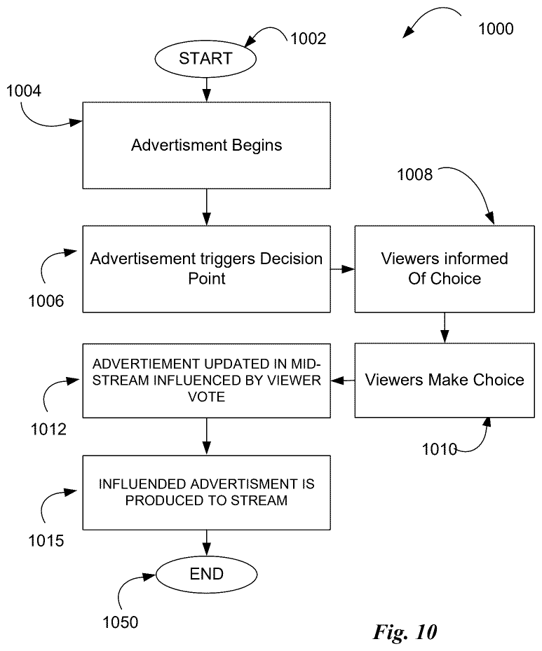

In this embodiment, the production engine 260 may include a sub-engine for real-time advertisement integration 265 that may draw upon a number of assembled advertising elements and or a number of paid-for elements for integration in a stored database. As advertisement are placed in production streams, opportunities exist to alter the advertisements in mid-stream by monitoring and utilizing viewer (e.g., consumer feedback in real-time via a feedback module 266. The production engine may include a real-time advertisement builder 267 that can assemble advertisement content for a live production stream based upon the viewer feedback and then an Influenced Advertisement Assimilation System 268 may alter one or more assets in an advertisement in accordance with assimilated feedback in real-time. Aspects of these methods are further detailed next with respect to FIG. 10.

FIG. 10 is a flow chart illustrating exemplary computer-based method for advertising content during content assembly, generation, and performance that is influenced by multiple consumers in real-time according to an embodiment of the subject matter disclosed herein. Methods include one or more steps depicted in FIG. 10. The DreamKey™ Multi-User Interactive Advertising module is a service that allows all simultaneous viewers of a video advertisement or commercial the ability to interact in real time with the ad to adjust the outcome. This can be as simple as choosing the narrative direction of an ad (voting for a particular outcome from a series of options) to the total viewers achieving enough interactions to reward all viewers with limited time offers, coupons, free product, and the like.

Advertisements are often video by nature, generally animated (though multiple live action video segments could be used as well.) Users can interact with the ad numerous ways depending on the platform or medium in which they watch (live-streaming platforms such as Twitch™ can involve commands typed into a chat, but we also support using TV controllers and apps as input devices.) The functional result is a commercial that could play out an almost infinite number of ways while still protected by guardrails that ensure that messaging is relayed exactly as it needs to be. It also can increase the value of commercials to the viewer by providing them real discounts and other rewards for participation. The DreamKey™ Multi-User Interactive Advertisements module allows for dynamic ads with viewer engagement that is scalable from as few as one viewer to as many as millions.

In the embodiment of FIG. 10, the overall method 1000 begins at a start step 1002 and proceeds to start streaming an advertisement at step 1004. Advertisement assets are created for a commercial—backgrounds, characters, animation sets, cameras, clothes and more. An outline of themes, branding, basic idea of the commercial, branching paths, character motivations, and possible rewards are loaded into the Brain along with any messaging that must be said in a specific way (such as medical footnotes, legal notifications, or specific brand language) so as to stick to brand guidelines. The audience does not have a chance to interact or change the locked in messaging. The advertisement is generally generated on the fly using AI LLMs to handle scene management as well as any dialogue that can be based on character motivations and general theme. It is possible using this method to load a number of pre-generated scenes into the Brain and have it choose a pathway through those scenes based on audience behavior as well.

At an inflection point (step 1006) in the ad, the audience is presented (step 408) with choices/actions. In a first example, the audience may be presented with a decision point for 1) making a choice about where the commercial goes (e.g., a cookie elf comes to a path in the woods and can a) go into his tree house, b) go down the well let path with a billboard that reads “FREE COOKIES” or c) can go down the dark and spooky path. Each audience member makes a choice (step 1010) in a timed window and the majority vote will dictate the rest of the ad.

In a second example, the audience is presented with a goal such as “if the viewers can manage to write ‘#FreeCookies’ in the chat 1000 total times they will receive a coupon for a free Cookie Elf cookie.” Upon reaching this goal, digital coupons may be distributed. If the condition is failed, no coupons are distributed, and the character onscreen can inform the consumers of disappointment.

In a third example, audience members are asked to make text or voice suggestions about what should happen next. This is more open-ended but with DreamKey™ generation it is possible to create a whole new path based on audience suggestions, such as at an improvisation show.

Once choices are made, the advertisement is influenced and changed in real-time at step 1012 and subsequently produced to the live stream at step 1014 before ending this branch of content creation at step 1050.

The systems and methods herein enable rapid ingestion of big data sets in a distributed computing environment. The metadata-driven approach intake processing reduces source ingestion time, enhances reliability, and automates data intake. Furthermore, the platform agnostic nature of the present disclosure can operate on an input source in any electronic format. The error logging and reporting of the present disclosure further enable users to monitor progress and identify bad data based on predetermined or dynamically generated validation tolerances.

As used herein, “match” or “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Any communication, transmission and/or channel discussed herein may include any system or method for delivering content (e.g., data, information, metadata, and the like), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE® TV®, PANDORA®, XBOX®, SONY® PLAYSTATION®), a uniform resource locator (“URL”), a document (e.g., a MICROSOFT® Word® document, a MICROSOFT® Excel® document, an ADOBE®.pdf document, and the like), an “eBook,” an “emagazine,” an application or microapplication (as described herein), an SMS or other type of text message, an email, Facebook, Twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include client data; merchant data; financial institution data; and/or like data useful in the operation of the system. As those skilled in the art will appreciate, user computer may include an operating system (e.g., WINDOWS® NT®, WINDOWS® 95/98/2000®, WINDOWS® XP®, WINDOWS® Vista®, WINDOWS® 7®, OS2, UNIX®, LINUX®, SOLARIS®, MacOS, and the like) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer systems can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc., which is read by and written to by the removable storage drive. As will be appreciated, the removable storage unit includes a computer-usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer systems and external devices. Examples of communications interface may include a modem, a network interface (such as an Ethernet account), a communications port, a Personal Computer Memory Account International Association (PCMCIA) slot and account, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular 30 link, a radio frequency (RF) link, wireless and other communications channels.

The terms “computer program medium” and “computer-usable medium” and “computer-readable medium” are used to generally refer to media such as removable storage drive and a hard disk installed in hard disk drive. These computer program products provide software to computer systems.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program and loaded into computer system using removable storage drive, hard disk drive or communications interface. The control logic (software), when executed by the processor, causes the processor to perform the functions of various embodiments as described herein. In various embodiments, hardware may include components such as application-specific integrated circuits (ASICs). Implementation of the hardware state machine so as to perform the functions described herein will be apparent to persons skilled in the relevant art(s).

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

Any databases discussed herein may include relational, hierarchical, graphical, or object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix, MySQL, Interbase, and the like, may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVAR APPLE®, JAVASCRIPT, active server pages (ASP) common gateway interface scripts (CGI), extensible markup language (XML), dynamic HTML, cascading style sheets (CSS), AJAX (Asynchronous JAVASCRIPT and XML), helper applications, plug-ins, and the like. A server may include a web service that receives a request from a web server, the request including a URL and an IP address (123.56.555.234). The web server retrieves the appropriate web pages and sends the data or applications for the web pages to the IP address. Web services are applications that are capable of interacting with other applications over a communication means, such as the internet. Web services are typically based on standards or protocols such as XML, SOAP, AJAX, WSDL and UDDI. Web services methods are well known in the art and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on an Internet server. Middleware may be configured to process transactions between the various components of an application server and any number of internal or external systems for any of the purposes disclosed herein. WEBSPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, maps, color-coded data sets, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as R, C, C++, C#, JAVA, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an Internet-based embodiment, an entirely hardware embodiment, or an embodiment combining aspects of the Internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method are described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general-purpose computer, special-purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special-purpose hardware-based computer systems which perform the specified functions or steps, or suitable combinations of special-purpose hardware and computer instructions. Further, illustrations of process flow and the descriptions thereof may make reference to use WINDOWS®, webpages, websites, web forms, prompts, and the like. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location.

Systems, methods and computer program products are provided. In the detailed description herein, references to “various embodiments”, “one embodiment”, “an embodiment”, “an example embodiment”, and the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

Since many modifications, variations, and changes in detail can be made to the described preferred embodiments of the subject matter, it is intended that all matters in the foregoing description and shown in the accompanying drawings be interpreted as illustrative and not in a limiting sense. Thus, the scope of the subject matter should be determined by the appended claims and their legal equivalence.

What is claimed is:

1. A computing system for audio and video generated content, comprising:
one or more processors configured to execute stored computer-readable instructions to:
assemble a plurality of audio assets;
assemble a plurality of video assets;
receive a first set of directives for content generation;
parsing the plurality of audio assets, the plurality of video assets and the first set of directives to generate a first rendition of an AV-content presentation;
receiving a second set of directives corresponding to consumption of the first rendition; and
generating a second rendition of the AV content presentation that is different from the first rendition.

2. The computing system of claim 1, wherein the one or more processors are further configured to execute stored computer-readable instructions to:
receive a plurality of character definitions, wherein each character definition comprises at least one physical attribute, at least one psychological attribute, and at least one voice control parameter; and
associate each character definition with at least one of the plurality of audio assets and at least one of the plurality of video assets.

3. The computing system of claim 2, wherein the one or more processors are further configured to execute stored computer-readable instructions to:
receive a timeline definition comprising a plurality of sequential events for the AV-content presentation;
associate each sequential event with at least one character definition; and
generate the first rendition of the AV-content presentation based on the timeline definition.

4. The computing system of claim 1, wherein the one or more processors are further configured to execute stored computer-readable instructions to:
receive audience interaction data during consumption of the first rendition;
analyze the audience interaction data to identify at least one content modification parameter; and
generate the second rendition of the AV-content presentation based on the at least one content modification parameter.

5. The computing system of claim 1, wherein the one or more processors are further configured to execute stored computer-readable instructions to:
track usage of a plurality of measured elements during generation of the first rendition, wherein the plurality of measured elements comprise at least one of music, audio samples, voice usage, character usage, art, and character personality elements; and
generate a usage report identifying consumption of each measured element.

6. The computing system of claim 1, wherein the one or more processors are further configured to execute stored computer-readable instructions to:
receive a script comprising dialogue for a plurality of characters;
generate audio content for each character using a text-to-speech model; and
synchronize the audio content with corresponding video assets to generate the first rendition of the AV-content presentation.

7. The computing system of claim 1, wherein the one or more processors are further configured to execute stored computer-readable instructions to:
receive a plurality of show parameters comprising at least one of show description, show vibe, show length, allowed content restrictions, sound effects libraries, music libraries, and location libraries; and
generate the first rendition of the AV-content presentation based on the plurality of show parameters.

8. The computing system of claim 1, wherein the one or more processors are further configured to execute stored computer-readable instructions to:
communicate with at least one third-party application programming interface to receive content generation input;
process the content generation input using a large language model to generate a script; and
generate the first rendition of the AV-content presentation based on the script.

9. The computing system of claim 1, wherein the one or more processors are further configured to execute stored computer-readable instructions to:
receive real-time audience input during consumption of the first rendition;
modify the second set of directives based on the real-time audience input; and
generate the second rendition of the AV-content presentation in response to the modified second set of directives.

10. A computer-based method for audio and video generated content, comprising:
assembling, by one or more processors, a plurality of audio assets;
assembling, by the one or more processors, a plurality of video assets;
receiving, by the one or more processors, a first set of directives for content generation;
parsing, by the one or more processors, the plurality of audio assets, the plurality of video assets and the first set of directives to generate a first rendition of an AV-content presentation;
receiving, by the one or more processors, a second set of directives corresponding to consumption of the first rendition; and
generating, by the one or more processors, a second rendition of the AV-content presentation that is different from the first rendition.

11. The computer-based method of claim 10, further comprising:
receiving, by the one or more processors, a plurality of character definitions, wherein each character definition comprises at least one physical attribute, at least one psychological attribute, and at least one voice control parameter; and
associating, by the one or more processors, each character definition with at least one of the plurality of audio assets and at least one of the plurality of video assets.

12. The computer-based method of claim 11, further comprising:
receiving, by the one or more processors, a timeline definition comprising a plurality of sequential events for the AV-content presentation;
associating, by the one or more processors, each sequential event with at least one character definition; and
generating, by the one or more processors, the first rendition of the AV-content presentation based on the timeline definition.

13. The computer-based method of claim 10, further comprising:
receiving, by the one or more processors, audience interaction data during consumption of the first rendition;
analyzing, by the one or more processors, the audience interaction data to identify at least one content modification parameter; and
generating, by the one or more processors, the second rendition of the AV-content presentation based on the at least one content modification parameter.

14. The computer-based method of claim 10, further comprising:
tracking, by the one or more processors, usage of a plurality of measured elements during generation of the first rendition, wherein the plurality of measured elements comprise at least one of music, audio samples, voice usage, character usage, art, and character personality elements; and
generating, by the one or more processors, a usage report identifying consumption of each measured element.

15. The computer-based method of claim 10, further comprising:
receiving, by the one or more processors, a script comprising dialogue for a plurality of characters;
generating, by the one or more processors, audio content for each character using a text-to-speech model; and
synchronizing, by the one or more processors, the audio content with corresponding video assets to generate the first rendition of the AV-content presentation.

16. The computer-based method of claim 10, further comprising:
receiving, by the one or more processors, a plurality of show parameters comprising at least one of show description, show vibe, show length, allowed content restrictions, sound effects libraries, music libraries, and location libraries; and
generating, by the one or more processors, the first rendition of the AV-content presentation based on the plurality of show parameters.

17. The computer-based method of claim 10, further comprising:
communicating, by the one or more processors, with at least one third-party application programming interface to receive content generation input;
processing, by the one or more processors, the content generation input using a large language model to generate a script; and
generating, by the one or more processors, the first rendition of the AV-content presentation based on the script.

18. The computer-based method of claim 10, further comprising:
receiving, by the one or more processors, real-time audience input during consumption of the first rendition;
modifying, by the one or more processors, the second set of directives based on the real-time audience input; and
generating, by the one or more processors, the second rendition of the AV-content presentation in response to the modified second set of directives.

19. A computing system for audio and video generated content, comprising:
one or more processors configured to execute stored computer-readable instructions, wherein the one or more processors are configured to:
assemble a plurality of audio assets;
assemble a plurality of video assets;
receive a first set of directives for content generation;
parse the plurality of audio assets, the plurality of video assets and the first set of directives to generate a first rendition of an AV-content presentation;
receive a second set of directives corresponding to consumption of the first rendition; and
generate a second rendition of the AV-content presentation that is different from the first rendition.

20. The computing system of claim 19, wherein the second set of directives comprises input from a live viewing audience.
